(19) United States
(12) Patent Application Publication
(10) Pub. No.: US 2025/0328452 A1
(43) Pub. Date: Oct. 23, 2025

(54) NON-PAUSE REALTIME BREAKPOINT SYSTEMS AND METHODS

(71) Applicant: Hamilton Sundstrand Corporation, Charlotte, NC (US)

(72) Inventors: Manu Bittugondanahalli Indrakumar, Bangalore (IN); Balaji Krishnakumar, Bangalore (IN)

(21) Appl. No.: 18/768,992

(22) Filed: Jul. 10, 2024

(30) Foreign Application Priority Data
Apr. 23, 2024 (IN) 202441032190

(51) Int. Cl. G06F 11/36; G06F 11/07

(52) U.S. Cl. CPC G06F 11/3644; G06F 11/0772; G06F 11/3636

(57) ABSTRACT

A method includes receiving a callback routine creation command at a target device. The method also includes creating a callback routine in a callback memory space included in memory of the target device after validating the same. The method also includes receiving a set breakpoint command at the target device. The method also includes, in response to the received set breakpoint command, setting a breakpoint at the target device. The method can also include identifying a breakpoint hit, generating, by an exception inducing instruction, an interrupt, identifying a breakpoint control block in an active breakpoints data structure. The method also can also include invoking the callback routine and storing an opcode at a memory address, wherein the memory address is in a predetermined memory region of the memory, and wherein the breakpoint control block stores the opcode and the memory address.

### CROSS-REFERENCE TO RELATED APPLICATION(S) AND CLAIM OF PRIORITY

This application claims priority to Indian Provisional Application No. 202441032190, filed Apr. 23, 2024, the disclosure of which is incorporated herein by reference in its entirety.

### TECHNICAL FIELD

This disclosure relates generally to computing systems. More specifically, this disclosure relates to non-pause realtime breakpoint systems and methods.

### BACKGROUND

Systems such as avionics systems often comprise multiple concurrently running subsystems like direct memory access, analog to digital converters, communication interfaces, etc. During debugging or testing, especially while performing an emulator-based testing, breakpoints are used. Whenever the breakpoint is hit, the processor is halted to capture/modify the current state. However, this can create problems because there could be many other concurrently running subsystems which should not or may not be able to halt. This results in synchronization issues with respect to these other subsystems within the system.

### SUMMARY

This disclosure provides non-pause realtime breakpoint systems and methods.

In one aspect, a method includes establishing a communication link between a target device and a host device. The method also includes receiving a callback routine creation command at the target device. The method also includes creating, in response to the received callback routine creation command, a callback routine in a callback memory space included in memory of the target device. The method also includes receiving a set breakpoint command at the target device. The method also includes, in response to the received set breakpoint command, setting a breakpoint at the target device.

In another aspect, an electronic device includes at least one processing device and memory. The memory includes instructions that, when executed by the at least one processing device, are configured to cause the electronic device to establish a communication link between a target device and a host device, receive a callback routine creation command at the target device, create, in response to the received callback routine creation command, a callback routine in a callback memory space of the target device, receive a set breakpoint command at the target device, and, in response to the received set breakpoint command, set a breakpoint at the target device.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example host-target interface architecture in accordance with this disclosure;

FIG. 2 illustrates an example host debugging interface process in accordance with this disclosure;

FIG. 3 illustrates an example target debugging link interface process in accordance with this disclosure;

FIG. 4 illustrates an example target debugging link utility process in accordance with this disclosure;

FIG. 5 illustrates an example callback routine creation command process in accordance with this disclosure;

FIG. 6 illustrates an example set breakpoint command process in accordance with this disclosure;

FIG. 7 illustrates an example breakpoint hit process in accordance with this disclosure;

FIG. 8 illustrates an example breakpoint clear command process in accordance with this disclosure;

FIGS. 9A and 9B illustrate an example method for setting and processing breakpoints in accordance with this disclosure; and

FIG. 10 illustrates an example electronic device in accordance with this disclosure.

### DETAILED DESCRIPTION

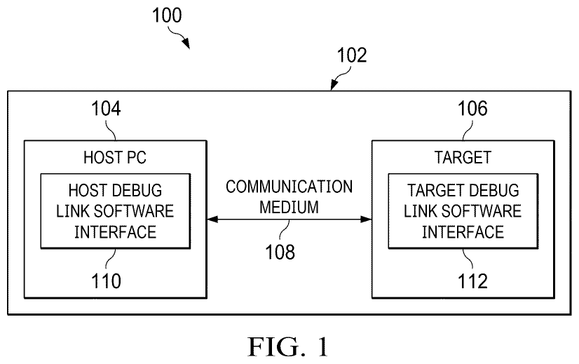

FIGS. 1 through 10, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

Systems such as avionics systems often comprise multiple concurrently running subsystems like direct memory access, analog to digital converters, communication interfaces, etc. During debugging or testing, especially while performing an emulator-based testing, breakpoints are used. Whenever the breakpoint is hit, the processor is halted to capture/modify the current state. However, this can create problems because there could be many other concurrently running subsystems which should not or may not be able to halt. This results in synchronization issues with respect to these other subsystems within the system.

When such synchronization issues with respect to other concurrently running subsystems are encountered because the other subsystems are not able to halt when the processor halts on a breakpoint hit, the real time behavior of the system cannot be captured and/or modified, which is often required for hardware software integration testing or real time hardware simulations.

This disclosure provides for a non-pause, realtime, debugging technique/process where, on a breakpoint hit, instead of pausing the processor, a user configurable routine is invoked which is loaded prior to the breakpoint set operation. This process captures and/or modifies the current state of a variable in an intermediate location of the processor and immediately continues the execution of the next instruction without pausing. The user can read the state of the variables at the time of the breakpoint hit by reading the contents of the intermediate location. This debugging process provides various benefits, including that the debugging process of this disclosure is emulator-less such that testing and debugging can be performed without using emulators.

The debugging process of this disclosure also allows for establishing a common testing framework. Also, when the debugging process of this disclosure is used as part of software in flight systems, the software is not part of the actual flight software, and thus simple qualification is sufficient. Often, using multiple test environments such as emulators, software integration testing and hardware software integration testing, and real time hardware simulations is not feasible within the flight software, but the non-pause, realtime, debugging process of this disclosure can be executed separately from the flight software.

FIG. 1 illustrates an example host-target interface architecture 100 in accordance with this disclosure. As shown in FIG. 1, the host-target interface architecture 100 includes an environment 102 in which a host device 104 is connected to a target device 106 via a communication medium 108. The host device 104 executes a host debugging link software interface 110 that links to a target debugging link software interface 112 executed by the target device 106. During a debugging and/or testing phase, a portion of the random access memory (RAM) of the system of the target device 106 is reserved as a pseudo flash region in order to enable the software to use software breakpoints.

Target software is first loaded onto the pseudo flash region of the target device 106 and the software is executed. Then, the target debug link software interface 112, which can be at least part of debug link utility of the target software on the target device 106, establishes the communication link with the host debugging link software interface 110 of the host device 104 through which host-target interactions occur. The host debug link software interface 110 of the host device 104, which can be link utility software part of the host device 104 software, communicates with the target debug link software interface 112 software through the communication medium 108, such as via a command-response type protocol. In various embodiments, the communication medium 108 is a configurable component in both the host debug link software interface 110 and target debug link software interface 112, and can be any appropriate communication medium.

Although FIG. 1 illustrates one example of a host-target interface architecture 100, various changes may be made to FIG. 1. For example, various components and functions in FIG. 1 may be combined, further subdivided, replicated, or rearranged according to particular needs. Also, one or more additional components and functions may be included if needed or desired.

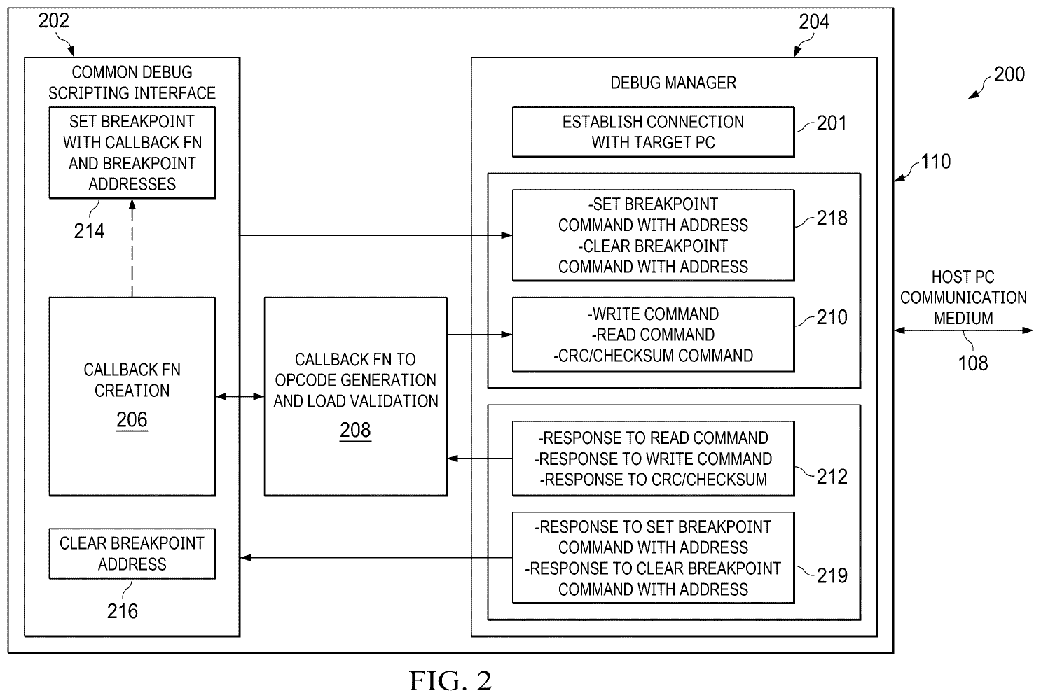

FIG. 2 illustrates an example host debugging interface process 200 in accordance with this disclosure. As shown in FIG. 2, the host interface 110 can include a common debug scripting interface 202 and a debug manager 204. The common debug scripting interface 202 allows users to script different command instruction phenomics such as a create callback function operation 206, a set breakpoint operation 214, a clear breakpoint operation 216, and an error identification operation such as a cyclic redundancy check (CRC) and/or checksum routine, which can all be in a scripting console or executed using a script file containing these commands. During the process 200, the scripting interface 202 invokes the callback creation command 206. The callback create command 206 is converted into its equivalent opcode to form a complete callback function 208. The function opcodes are converted into series of commands 210 and the opcodes are sent to the target interface 112 over the communication medium 108 to load the complete callback function 208 at the callback memory space area using a series of commands 210 including read, writes, and CRC/checksum commands.

It will be understood that the debug manager 204 can perform a connection establishment operation 201 to establish the connection with the target device 106 over the communication medium 108. Thus, when invoking the callback function operation 206 via the common debug scripting interface 202, the callback function is converted into equivalent processor-specific opcodes and the converted opcodes are sent to the debug manager 204 which will convert the callback function routine opcodes into the series of commands 210 including the write commands. The command instructions sent by the common debug scripting interface software 202 to the debug manager 204 are converted by the debug manager 204 into a communication medium specific command(s) and the debug manager 204 transmits them across the physical communication medium 108 after establishing the connection with the target device 106 via operation 201 in order to load the callback function into the target device 106. Once the callback function is loaded, it is validated at the target device 106 by using the CRC/checksum command.

Each of the executed commands waits for its response from the target device 106. If the current command executed successfully then it proceeds with a next script command in the interface, if there is no response or a negative acknowledgement is received, the script stops execution with an error message. In various embodiments, the common debug scripting interface is also capable of logging data regarding the process 200 to a file.

The debug manager 204 provides to the scripting interface 202 notifications/responses 212 to each of the read, write, and CRC/checksum commands. On successful validation of the loaded callback function 208, the debug manager 204 also notifies the scripting interface 202 to proceed with the next scripting command. If the validation is not successful, the scripting interface 202 will perform exception handling.

Once the callback function is successfully loaded, the scripting interface 202 can invoke a breakpoint command 214 to set a breakpoint at an address location with the above loaded callback function 208 as a callback routine. In some embodiments, the create callback function operation 206 is invoked prior to invocation of the set breakpoint operation 214, else set breakpoint command 214 will throw an error. The set breakpoint command 214 is sent by the common debug scripting interface 202 to the debug manager 204. The debug manager 204 includes a set of breakpoint commands 218 that includes setting a breakpoint command with an address and another set of response commands 219 that includes sending a response to the set breakpoint command with the address to confirm performance of the command. As shown in FIG. 2, the set of breakpoint commands 218 of the debug manager 204 also includes a clear breakpoint command with address command that is triggered by the clear breakpoint address command 216 invoked via the common debug scripting interface 202. The set of response commands 219 of the debug manager 204 also includes a corresponding response to clear breakpoint with address command that notifies the common debug scripting interface 202 whether a breakpoint has been successfully cleared.

The debug utility software thus provides a non-pause realtime breakpoint mechanism including the ability to: 1) set/clear software breakpoints; 2) create and configure callback functions; 3) read/write memory regions; 4) compute CRC/checksums; and 5) on any breakpoint hit it will save the breakpoint context and invoke its associated callback function and upon completion of the callback function execution clear the software breakpoint and continue execution of the software upon restoring the breakpoint context.

Although FIG. 2 illustrates one example of a host debugging interface process 200, various changes may be made to FIG. 2. For example, various components and functions in FIG. 2 may be combined, further subdivided, replicated, or rearranged according to particular needs. Also, one or more additional components and functions may be included if needed or desired.

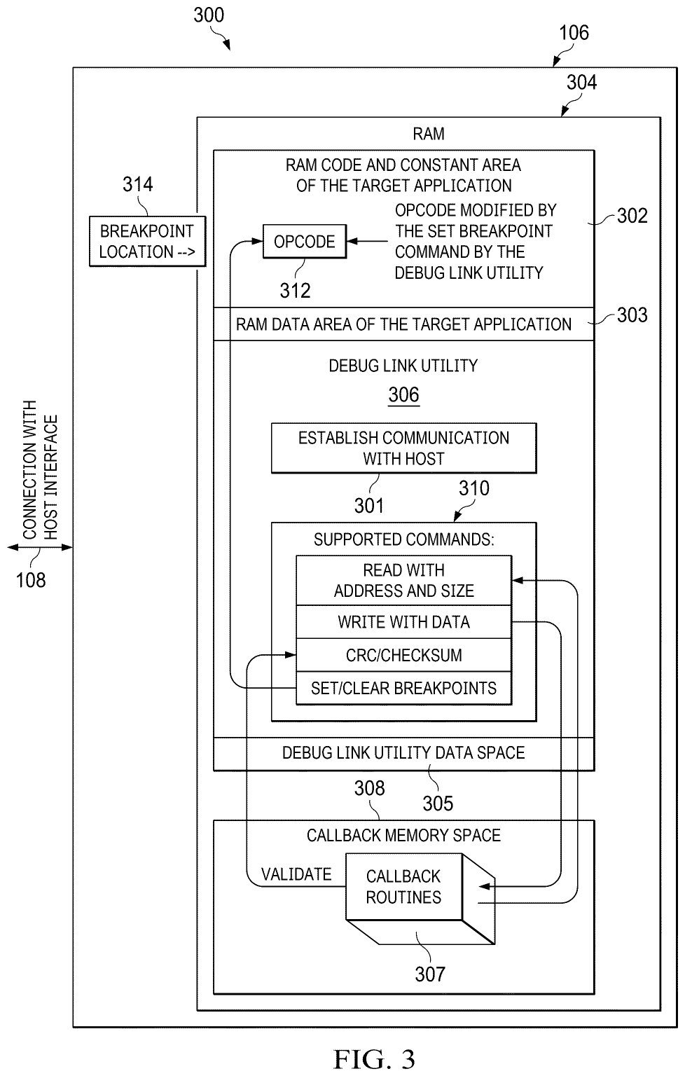

FIG. 3 illustrates an example target debugging link interface process 300 in accordance with this disclosure. As shown in FIG. 3, the target debug interface 112 includes target application software, having target application memory space 302, that is loaded into a pseudo flash region in RAM 304 of the target device 106 in order to support software breakpoints. The target application software 302 has an associated ram data area 303. The target debugging interface 112 also includes debug link utility software 306 that is loaded into the RAM 304. As shown in FIG. 3, the debug link utility software has an associated debug link utility data space 305 in the RAM 304 of the target device 106. The debug link utility software 306 is periodically invoked by the target application to establish communication with the host device interface 110 over the communication medium 108 using a communication establishment operation 301.

Once the communication with the host device 104 is established, as also described with respect to FIG. 2, the host device 104 sends series of write commands (e.g., the series of commands 210) to load a callback routine(s) 307 in a callback memory space 308 of the RAM 304. The debug link utility 306 supports software breakpoints using a set of supported commands 310. The set of supported commands 310 include a read command to read the address and size associated with the callback routines 307 in the callback memory space 308, write data to the callback memory space 308, perform CRC/checksum operations on the data written to the callback memory space 308, and set and clear breakpoint commands to set breakpoint opcodes in the target application memory space 302 and clear breakpoints.

Once the callback routine 307 is loaded, as also described with respect to FIG. 2, the host interface 110 sends CRC/checksum commands to the target debug link interface 112 to validate the callback routine 307. Also, once the callback routine 307 is loaded into the callback memory space 308, the host interface 110 can send a set breakpoint command, to be set in target application memory space 302. The breakpoint command invokes the configured callback routine 307 whenever a breakpoint is hit. As described with respect to FIG. 2, opcodes 312 provided by the host interface 110 are stored in the target application memory space 302 at one or more breakpoint locations 314. If there is a failure to load the callback routine 307 or the set breakpoint command is invoked without the callback routine 307 already being configured, the target debug link interface 112, via the debug link utility 306, can send a negative acknowledgement to the host interface 110.

Although FIG. 3 illustrates one example of a target debugging link interface process 300, various changes may be made to FIG. 3. For example, various components and functions in FIG. 3 may be combined, further subdivided, replicated, or rearranged according to particular needs. Also, one or more additional components and functions may be included if needed or desired.

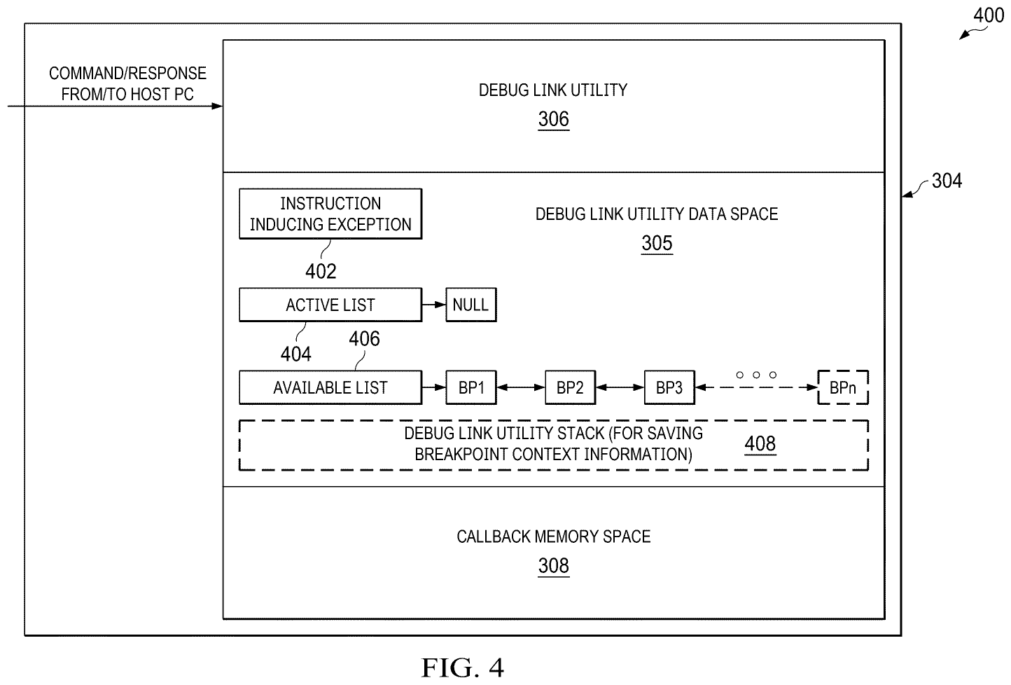

FIG. 4 illustrates an example target debugging link utility process 400 in accordance with this disclosure. As described with respect to FIG. 3, the target debug link interface 112 can include a debug link utility 306 loaded into RAM 304 that establishes communications with the host device 104 and cooperates with the host debug link interface 110 to create callback routines and set and clear breakpoints.

The target debugging link utility process 400 occurs after startup. Once debug link utility initialization is complete, data structures are initialized by the debug link utility 306 in the debug link utility data space 305. These data structures can include an exception inducing instruction 402. The exception inducing instruction 402 is an instruction opcode which, when executed, causes an exception and selects a specific opcode. This is generally a non-occurring pattern unless intentionally placed in code, such as an instruction generation alignment exception. The data structures also include an active breakpoints data structure 404 (e.g., a list) that is initially empty when created. The data structures also include an available software breakpoints data structure 406 that includes, for example, a list of created software breakpoints.

A debug link utility stack 408 is also created for saving breakpoint context information. The process 400 can also include initializing the callback memory space 308 for dynamically creating the callback routines 307 through the series of write and CRC/Checksum commands for callback function creation, as described with respect to FIGS. 2 and 3.

Although FIG. 4 illustrates one example of a target debugging link utility process 400, various changes may be made to FIG. 4. For example, various components and functions in FIG. 4 may be combined, further subdivided, replicated, or rearranged according to particular needs. Also, one or more additional components and functions may be included if needed or desired.

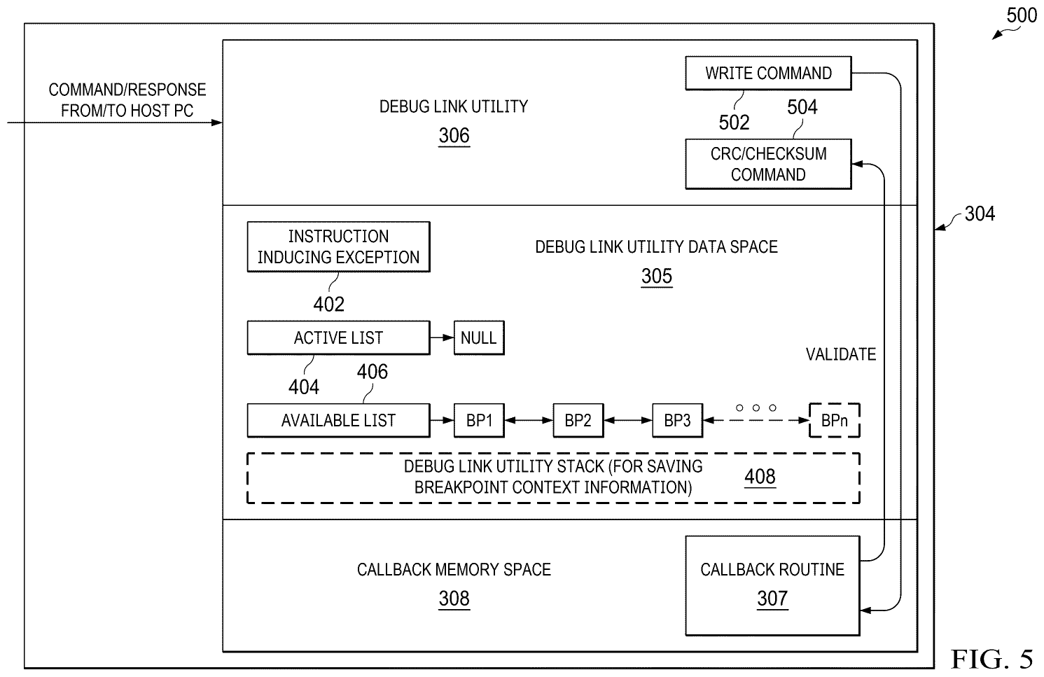

FIG. 5 illustrates an example callback routine creation command process 500 in accordance with this disclosure. As described with respect to FIG. 2, a callback routine is first created by the host device 104 via the scripting interface 202, including processing the callback routine and converting the callback routine into equivalent opcodes for the target device 106. This converted opcode is transferred from the host device 104 to the target device 106 using series of write commands in order to place the callback routine 307 in the callback memory space 308. Once the complete transfer of the callback routine 307 is successfully loaded into the callback memory space 308, the callback routine 307 is validated for its correctness through a CRC/Checksum command.

For example, as shown in FIG. 5, the debug link utility 306 on the target device 106 processes one or more write commands 502 received from the host device 104, which causes the callback routine 307 to be loaded in the callback memory space 308. Once the callback routine 307 is loaded, the host device 104 requests a CRC/checksum command 504 to validate the callback routine loaded. If the write command 502 could not be processed, such as if the write request 502 is to write at an invalid memory region, the debug link utility 306 can send a negative acknowledgement reply to the host device 104.

Although FIG. 5 illustrates one example of a callback routine creation command process 500, various changes may be made to FIG. 5. For example, various components and functions in FIG. 5 may be combined, further subdivided, replicated, or rearranged according to particular needs. Also, one or more additional components and functions may be included if needed or desired.

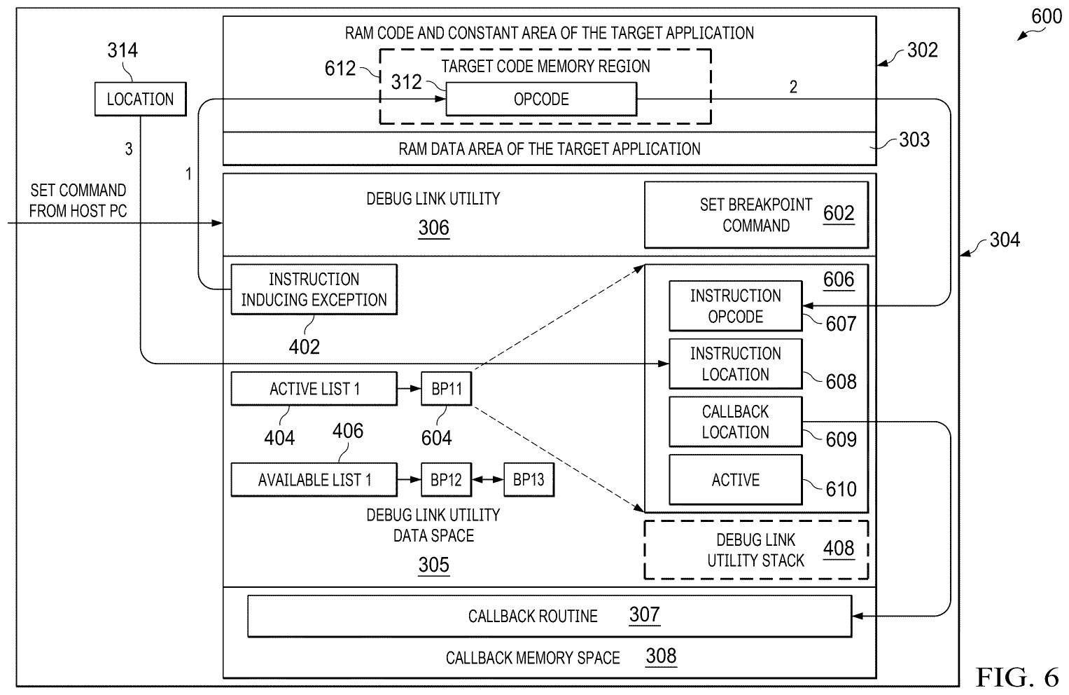

FIG. 6 illustrates an example set breakpoint command process 600 in accordance with this disclosure. As shown in FIG. 6, once a set breakpoint command 602 is received by the debug link utility 306 from the host device 104, the debug link utility can perform a series of operations. For instance, the process 600 can include checking, via the debug link utility 306, if the instruction address specified in the received set breakpoint command 602 is a valid address, and, if not, sending, via the debug link utility 306, a negative acknowledgement back to the host device 104. The process 600 can also include checking via, the debug link utility 306, if the callback address specified in the received set breakpoint command 602 is a valid address, such that it is checked if the callback routine 307 is loaded in the callback memory space 308, and, if not, the process 600 includes sending, via the debug link utility 306, a negative acknowledgement back to the host device 104. The process 600 also includes checking, via the debug link utility 306, if a breakpoint control block is available in the available software breakpoints data structure 406, and, if not, the process 600 includes sending, via the debug link utility 306, a negative acknowledgement back to the host device 104.

As also shown in FIG. 6, the process 600 includes checking, via the debug link utility 306, if a breakpoint control block, e.g., the breakpoint control block 604, is available in the available software breakpoints data structure 406, and, if so, the process 600 includes, via the debug link utility 306, moving the breakpoint control block from the available software breakpoints data structure 406 to the active breakpoints data structure 404. The breakpoint control block includes a plurality of information 606, including instruction opcode information 607, instruction location information 608, callback location information 609, and active status information 610. The process 600 also includes copying the instruction at an instruction address specified by the set breakpoint command 602 to the instruction opcode information 607 of the breakpoint control block 604 that has been moved to the active list. The process 600 also includes copying the instruction address specified by the set breakpoint command 602 to the instruction location information 608 of the breakpoint control block 604 that has been moved to the active list. The process also includes setting the callback location information 609 in the breakpoint control block 604 that was moved to the active list with a callback address specified by the set breakpoint command 602.

The process 600 can further include changing, via the debug link utility at a first step shown in FIG. 6, content of an opcode 312 at the address specified by the set breakpoint command 602 using the exception inducing instruction 402. As shown in FIG. 6, the opcode 312 is stored in a target code memory region 612 of the target application memory space 302. This causes, at a second step shown in FIG. 6, the instruction opcode information 607 in the breakpoint control block 604 to be updated. At a third step shown in FIG. 6, this also causes the instruction location information 608 to be updated with the location 314 of the changed opcode 312.

The process 600 also includes marking the status of the breakpoint control block 604 as “active” in the active status information 610. The process 600 can also include sending, via the debug link utility, an acknowledgement to the host device 104 upon successful setting of a breakpoint.

Although FIG. 6 illustrates one example of a set breakpoint command process 600, various changes may be made to FIG. 6. For example, various components and functions in FIG. 6 may be combined, further subdivided, replicated, or rearranged according to particular needs. Also, one or more additional components and functions may be included if needed or desired.

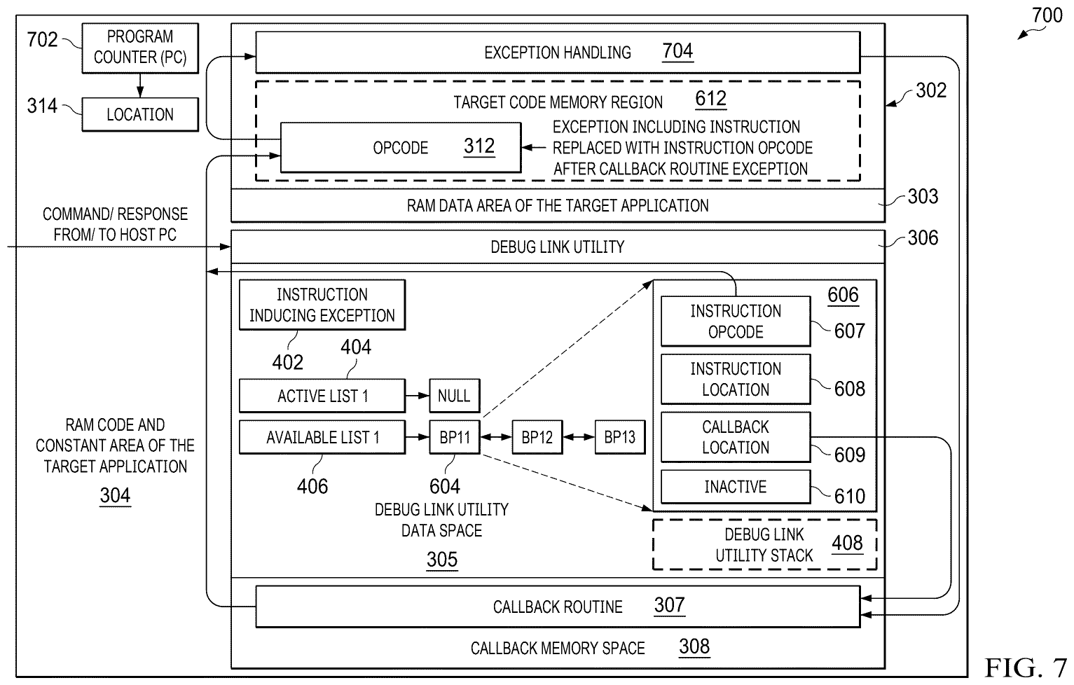

FIG. 7 illustrates an example breakpoint hit process 700 in accordance with this disclosure. During execution of the target application software, once a program counter 702 reaches any of the breakpoints set by the breakpoint set command 602, then breakpoint hit processing is performed. The process 700 includes executing the exception inducing instruction 402, which causes an interrupt to be generated that invokes an exception handler 704. The exception handler 704 can cause saving of the context of interrupt status and disables all interrupts. The exception handler 704 can also cause performance of a context saving by saving all the register contents in debug utility stack 408. The exception handler 704 also can cause identification of the breakpoint control block associated with the breakpoint which is hit, e.g., breakpoint control block 604 in the example shown in FIG. 7.

The exception handler 704 causes invocation of the callback routine 307 specified in the breakpoint control block 604 corresponding to the breakpoint which is hit. Once execution of the callback routine 307 is completed, the process 700 includes storing the saved instruction from the breakpoint control block 604 at the instruction location specified by the instruction location information 608 in the breakpoint control block 604. The breakpoint control block 604 is then moved from the active breakpoints data structure 404 to the available software breakpoints data structure 406 and is set to inactive in the active status information 610. The process 700 can further include restoring all the previously saved context registers, enabling all the previously disabled interrupts, and jumping back the control to the breakpoint instruction location.

Although FIG. 7 illustrates one example of a breakpoint hit process 700, various changes may be made to FIG. 7. For example, various components and functions in FIG. 7 may be combined, further subdivided, replicated, or rearranged according to particular needs. Also, one or more additional components and functions may be included if needed or desired.

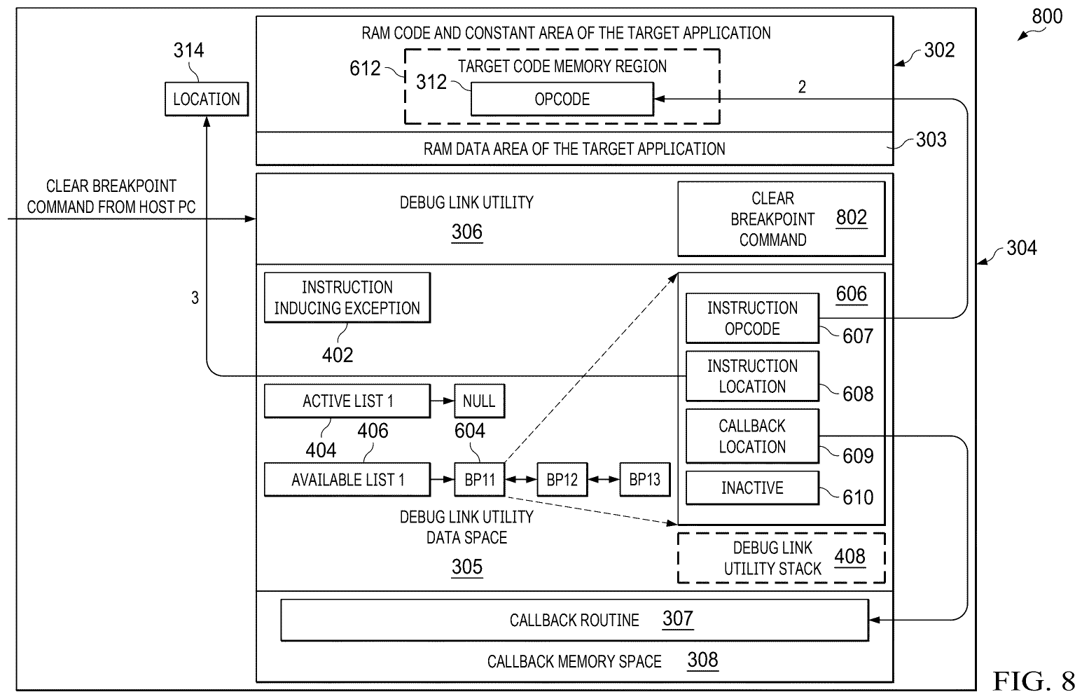

FIG. 8 illustrates an example breakpoint clear command process 800 in accordance with this disclosure. The process 800 includes receiving a clear breakpoint command 802 from the host device 104. Receipt of the breakpoint clear command 802 causes performance of various operations via the debug link utility 306. For instance, the process 800 can include checking, via the debug link utility 306, if the address is in a valid range of operation, and, if not, sending a negative acknowledgement back to the host device 104. The process 800 can also include checking, via the debug link utility 306, if a breakpoint control block, e.g., the breakpoint control block 604, is in the active breakpoints data structure 404, and, if not, sending a negative acknowledgement back to the host device 104.

The process 800 can also include moving, via the debug link utility 306, the breakpoint control block 604 from the active breakpoints data structure 404 to the available software breakpoints data structure 406. The process 800 can also include restoring, via the debug link utility 306, the instruction at the location specified by the clear breakpoint command with the instruction opcode information 607 of the breakpoint control block 604 that was moved to the available software breakpoints data structure 406. The process 800 also can include marking, via the debug link utility 306, the status of breakpoint control block as inactive in the active status information 610. The process 800 can then include sending back an acknowledgement to the host device 104 upon successful clearing of the breakpoint.

Although FIG. 8 illustrates one example of a breakpoint clear command process 800, various changes may be made to FIG. 8. For example, various components and functions in FIG. 8 may be combined, further subdivided, replicated, or rearranged according to particular needs. Also, one or more additional components and functions may be included if needed or desired.

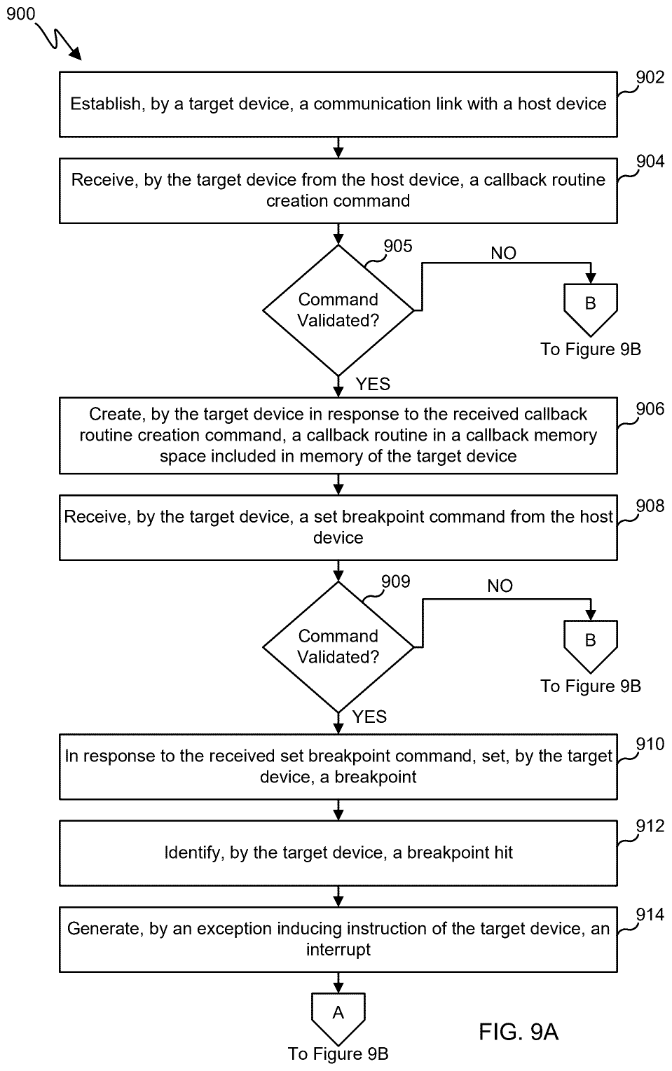

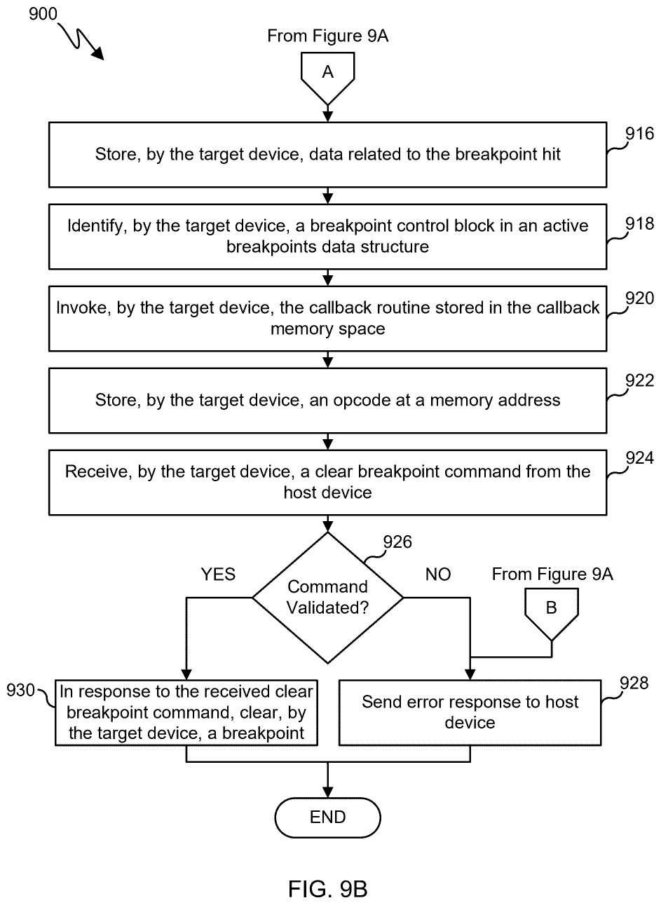

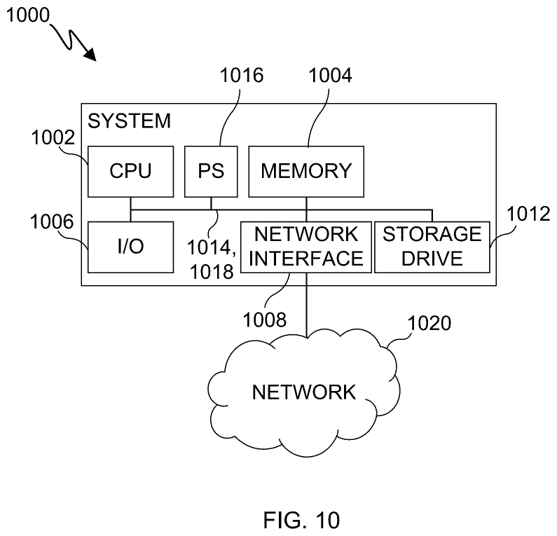

FIGS. 9A and 9B illustrate an example method 900 for setting and processing breakpoints in accordance with this disclosure. For ease of explanation, the method 900 shown in FIGS. 9A and 9B is described as being performed using the electronic device 1000 of FIG. 10. However, the method 900 could be performed using any other suitable device(s), and in any other suitable system(s).

As described with respect to FIGS. 1 through 8, the target device can perform various processes related to software breakpoint processing. For example, at step 902, the processor of the target device establishes a communication link with a host device. At step 904 the processor of the target device receives, from the host device, a callback routine creation command. At step 905, as described in this disclosure, the processor of the target device can determine whether the received command is validated. If not, at step 928, the target device performs error handling, which can include sending an error response to the host device. However, if, at step 905, the target device determines the received command is validated, then, at step 906, the processor of the target device creates, in response to the received callback routine creation command, a callback routine in a callback memory space included in memory of the target device. In various embodiments, the processor can validate the created callback routine using an error identification operation.

At step 908, the processor of the target device receives a set breakpoint command from the host device. At step 909, as described in this disclosure, the processor of the target device can determine whether the received command is validated. If not, at step 928, the target device performs error handling, which can include sending an error response to the host device. However, if, at step 909, the target device determines the received command is validated, then, at step 910, the processor of the target device, in response to the received set breakpoint command, sets a breakpoint. In various embodiments of this disclosure, setting the breakpoint can include moving a breakpoint control block from an available breakpoints data structure to the active breakpoints data structure, changing, via an exception inducing instruction, content of the opcode specified by the set breakpoint command, updating the breakpoint control block to include the opcode based on the changed content of the opcode and the memory address of the opcode, and marking a status of the breakpoint control block as active. In various embodiments, the breakpoint control block comprises a plurality of information including instruction opcode information, instruction location information, callback location information, and active status information.

In various embodiments, setting the breakpoint can also include sending an acknowledgement indicating successful setting of the breakpoint to the host device. In some embodiments, setting the breakpoint can further include sending a negative acknowledgement to the host device in response to at least one of an instruction address specified in the received set breakpoint command is not a valid instruction address, a callback address specified in the received set breakpoint command is not a valid callback address, and the breakpoint control block is not available in the available breakpoints data structure.

At step 912, the processor of the target device identifies a breakpoint hit. At step 914, the processor of the target device generates, by an exception inducing instruction of the target device, an interrupt. At step 916, the processor of the target device stores data related to the breakpoint hit. At step 918, the processor of the target device identifies a breakpoint control block in an active breakpoints data structure. At step 920, the processor of the target device invokes the callback routine stored in the callback memory space. At step 922, the processor of the target device stores an opcode at a memory address, where the memory address is in a predetermined memory region of the memory, and where the breakpoint control block stores the opcode and the memory address.

In various embodiments, the processor can also reserve a portion of the memory as a pseudo flash region for performing breakpoint processing by the target device. This allows for the data related to the breakpoint to be stored in a debug utility stack in a predefined data space of the pseudo flash region. In various embodiments, storing the data related to the breakpoint hit includes disabling other interrupts, saving realtime operating system (RTOS) timer values in the debug utility stack, and saving register contents in the debug utility stack.

In various embodiments, the method 900 can also include clearing a breakpoint. For example, to clear a breakpoint, at step 922, the processor of the target device receives a clear breakpoint command. At step 926, as described in this disclosure, the processor of the target device can determine whether the received command is validated. If not, at step 928, the target device performs error handling, which can include sending an error response to the host device. However, if, at step 926, the target device determines the received command is validated, then, at step 930, in response to the received clear breakpoint command, the target device clears the breakpoint. This can include the processor moving the breakpoint control block from the active breakpoints data structure to an available breakpoints data structure. The processor can also restore an instruction at a memory location specified by the clear breakpoint command with the opcode in the breakpoint control block.

Although FIGS. 9A and 9B illustrate one example of a method 900 for setting and processing breakpoints, various changes may be made to FIGS. 9A and 9B. For example, while shown as a series of steps, various steps in FIGS. 9A and 9B could overlap, occur in parallel, occur in a different order, or occur any number of times (including zero times).

FIG. 10 illustrates an example electronic device 1000 in accordance with various embodiments of this disclosure. The device 1000 can be one example of a portion of the host device 104 or the target device 106, or other devices. The device 1000 can include a controller (e.g., a processor/central processing unit (“CPU”)) 1002, a memory unit 1004, and an input/output (“I/O”) device 1006. The device 1000 also includes at least one network interface 1008, or network interface controllers (NICs), which can facilitate communications over the communication medium 108. The device 1000 also includes a storage drive 1012 used for storing content such as software resources and other data. The components 1002, 1004, 1006, 1008, and 1012 are interconnected by a data transport system (e.g., a bus) 1014. A power supply unit (PSU) 1016 provides power to components of the device 1000 via a power transport system 1018 (shown with data transport system 1014, although the power and data transport systems may be separate). Connections can be wired or wireless.

It is understood that the device 1000 may be differently configured and that each of the listed components may actually represent several different components. For example, the CPU 1002 may actually represent a multi-processor or a distributed processing system; the memory unit 1004 may include different levels of cache memory, and main memory; the I/O device 1006 may include monitors, keyboards, touchscreens, and the like; the at least one network interface 1008 may include one or more network cards providing one or more wired and/or wireless connections to a network 1020; and the storage drive 1012 may include hard disks and remote storage locations. Therefore, a wide range of flexibility is anticipated in the configuration of the device 1000, which may range from a single physical platform configured primarily for a single user or autonomous operation to a distributed multi-user platform such as a cloud computing system.

The device 1000 may use any operating system (or multiple operating systems), including various versions of operating systems provided by Microsoft (such as WINDOWS), Apple (such as Mac OS X), UNIX, RTOS, and LINUX, and may include operating systems specifically developed for handheld devices (e.g., iOS, Android, RTOS, Blackberry, and/or Windows Phone), personal computers, servers, and other computing platforms depending on the use of the device 1000. The operating system, as well as other instructions (e.g., for telecommunications and/or other functions provided by the device 1000), may be stored in the memory unit 1004 and executed by the processor 1002. The memory unit 1004 may include instructions for performing some or all of the steps, process, and methods described herein, such as data for the host or target software applications and the algorithms of the various embodiments of this disclosure.

The network 1020 may be a single network or may represent multiple networks, including networks of different types, whether wireless or wired. For example, the device 1000 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 1000 with external devices.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
establishing a communication link between a target device and host device;
receiving a callback routine creation command at the target device;
creating, in response to the received callback routine creation command, a callback routine in a callback memory space included in memory of the target device;
receiving a set breakpoint command at the target device; and
in response to the received set breakpoint command, setting a breakpoint at the target device.

2. The method of claim 1, further comprising:
identifying a breakpoint hit at the target device;
generating, by an exception inducing instruction, an interrupt;
storing data related to the breakpoint hit;
identifying a breakpoint control block in an active breakpoints data structure;
invoking the callback routine stored in the callback memory space; and
storing an opcode at a memory address, wherein the memory address is in a predetermined memory region of the memory, and wherein the breakpoint control block stores the opcode and the memory address.

3. The method of claim 2, wherein setting, by the target device, the breakpoint includes:
moving the breakpoint control block from an available breakpoints data structure to the active breakpoints data structure;
changing, via the exception inducing instruction, content of the opcode specified by the set breakpoint command;
updating the breakpoint control block to include the opcode based on the changed content of the opcode and the memory address of the opcode; and
marking a status of the breakpoint control block as active.

4. The method of claim 3, wherein setting the breakpoint further includes sending a negative acknowledgement to the host device in response to at least one of:
an instruction address specified in the received set breakpoint command is not a valid instruction address;
a callback address specified in the received set breakpoint command is not a valid callback address; or
the breakpoint control block is not available in the available breakpoints data structure.

5. The method of claim 2, further comprising reserving a portion of the memory as a pseudo flash region for performing breakpoint processing by the target device.

6. The method of claim 5, wherein the data related to the breakpoint is stored in a debug utility stack in a predefined data space of the pseudo flash region.

7. The method of claim 6, wherein storing the data related to the breakpoint hit includes:
disabling other interrupts; and
saving register contents in the debug utility stack.

8. The method of claim 2, wherein the breakpoint control block comprises a plurality of information including:
instruction opcode information;
instruction location information;
callback location information; and
active status information.

9. The method of claim 2, further comprising:
receiving, by the target device, a clear breakpoint command;
in response to receiving the clear breakpoint command, moving the breakpoint control block from the active breakpoints data structure to an available breakpoints data structure; and
restoring an instruction at a memory location specified by the clear breakpoint command with the opcode in the breakpoint control block.

10. The method of claim 1, further comprising validating, by the target device, the created callback routine using an error identification operation.

11. An electronic device comprising:
at least one processing device; and
memory including instructions that, when executed by the at least one processing device, are configured to cause the electronic device to:
establish a communication link between a target device and a host device;
receive a callback routine creation command at the target device;
create, in response to the received callback routine creation command, a callback routine in a callback memory space of the target device;
receive a set breakpoint command at the target device; and
in response to the received set breakpoint command, set a breakpoint at the target device.

12. The electronic device of claim 11, wherein the instructions, when executed by the at least one processing device, are further configured to cause the electronic device to:
identify a breakpoint hit at the target device;
generate, via an exception inducing instruction, an interrupt;
store data related to the breakpoint hit;
identify a breakpoint control block in an active breakpoints data structure;
invoke the callback routine stored in the callback memory space; and
store an opcode at a memory address, wherein the memory address is in a predetermined memory region, and wherein the breakpoint control block stores the opcode and the memory address.

13. The electronic device of claim 12, wherein the instructions that, when executed by the at least one processing device, are configured to cause the electronic device to set the breakpoint are further configured to cause the electronic device to:
move the breakpoint control block from an available breakpoints data structure to the active breakpoints data structure;
change, via the exception inducing instruction, content of the opcode specified by the set breakpoint command;
update the breakpoint control block to include the opcode based on the changed content of the opcode and the memory address of the opcode; and
mark a status of the breakpoint control block as active.

14. The electronic device of claim 13, wherein the instructions that, when executed by the at least one processing device, are configured to cause the electronic device to set the breakpoint are further configured to cause the electronic device to send a negative acknowledgement to the host device in response to at least one of:
an instruction address specified in the received set breakpoint command is not a valid instruction address;
a callback address specified in the received set breakpoint command is not a valid callback address; or
the breakpoint control block is not available in the available breakpoints data structure.

15. The electronic device of claim 12, wherein the instructions, when executed by the at least one processing device, are further configured to cause the electronic device to reserve a pseudo flash region for performing breakpoint processing.

16. The electronic device of claim 15, wherein the data related to the breakpoint is stored in a debug utility stack in a predefined data space of the pseudo flash region.

17. The electronic device of claim 16, wherein the instructions that, when executed by the at least one processing device, are configured to cause the electronic device to store the data related to the breakpoint hit are further configured to cause the electronic device to:
disable other interrupts; and
save register contents in the debug utility stack.

18. The electronic device of claim 12, wherein the breakpoint control block comprises a plurality of information including:
instruction opcode information;
instruction location information;
callback location information; and
active status information.

19. The electronic device of claim 12, wherein the instructions, when executed by the at least one processing device, are further configured to cause the electronic device to:
receive a clear breakpoint command;
in response to receipt of the clear breakpoint command, move the breakpoint control block from the active breakpoints data structure to an available breakpoints data structure; and
restore an instruction at a memory location specified by the clear breakpoint command with the opcode in the breakpoint control block.

20. The electronic device of claim 11, wherein the instructions, when executed by the at least one processing device, are further configured to cause the electronic device to validate the created callback routine using an error identification operation.
